(19) United States
(12) Patent Application Publication
(10) Pub. No.: US 2002/0170644 A1
(43) Pub. Date: Nov. 21, 2002

(54) Tread pattern for a tire for a vehicle of high loading capacity

(76) Inventor: Olivier Comps, Clermont-Ferrand (FR)

Correspondence Address: Michelin North America, Inc., Intellectual Property Department, P.O. Box 2026, Greenville, SC, 29602, US

(21) Appl. No.: 10/133,024

(22) Filed: Apr. 26, 2002

Related U.S. Application Data
(63) Continuation of application No. PCT/EP00/10116, filed on Oct. 13, 2000.

(30) Foreign Application Priority Data
Oct. 29, 1999 (FR) 99/13696

(51) Int. Cl. B60C 11/00

(52) U.S. Cl. 152/209.5; 152/209.25

(57) ABSTRACT

A tread for a tire for a vehicle of high loading capacity which travels on bumpy roadways, having a tread pattern comprising elements in relief formed by at least one first and one second cutout (1, 2) which are oriented differently. The first cutout (1) opens into the second cutout (2) without crossing it to form a T-shaped connecting region. The tread pattern according to the invention is characterized in that one of the walls (22) of the second cutout (2) is provided, in the connecting region, with a protrusion (6) which extends substantially in the direction of the first cutout (1), this protrusion (6) having, on a surface parallel to the running surface, a contour C, the point of which which is farthest from the second wall is at a distance at least equal to 50% of the width L2 of the second cutout (2). This protrusion reduces the maximum diameter of a spherical object which may be introduced into said connecting region.

This application is a continuation of PCT/EP00/10116 filed on Oct. 13, 2000, and published on May 10, 2001 as WO 01/32448 Al, in French.

### BACKGROUND OF THE INVENTION

The invention relates to tread patterns for tires intended to be fitted on vehicles of very high loading capacity, which travel in particular in quarries or on building sites, such as skip lorries, and so-called “dumper” vehicles.

The vehicles in question have a tread, the thickness of which makes it possible to produce cutouts (grooves and/or incisions) of a depth of at least 60 mm.

Within the scope of the present document, “groove” is understood to mean a cutout molded in the tread and defined by rubber walls, the typical width between said walls being at least 15 mm; the trace of a groove on the running surface may be of variable width. “Incision” is understood to mean a cutout of a width less than 15 mm.

It is customary to produce treads comprising a plurality of cutouts which are oriented circumferentially and transversely, some of said cutouts opening into at least one other cutout of different orientation.

During travel on ground comprising large numbers of stones, it was noted that certain regions of a tire tread pattern had increased susceptibility to picking up and retaining stones and other objects. In particular, in the case of a cutout which opens into another cutout of different orientation, but without completely crossing it, it was observed that the T-shaped connecting region, compared with the cutouts themselves, was more susceptible to retaining stones.

In fact, as is shown in FIG. 1, it is noted that in the T-shaped connecting region between two cutouts, the maximum size of the stones which can be picked up (which are represented by a circle) is greater than the average width of each cutout. Of course, the real size of the stones which can effectively be picked up is greater than that which is simulated, taking into account the low rigidity of the corners of the tread pattern motifs.

It will be observed that a stone of substantially spherical shape and of a diameter equal to the maximum size described will be able to be picked up in these T-shaped connecting zones and cannot escape by migrating to one or the other of the cutouts of lesser width (everything occurs as if this stone were to become more and more compressed between the rubber walls of the tread pattern motifs).

It is known in the case of tires for heavy vehicles to provide, at the bottom of the cutouts, blocks of rubber which protrude from the bottom of said cutouts in order to reduce the amount of certain stone types which are picked up by preventing them from passing into the cutouts, or even to eject them if they had nevertheless managed to penetrate into them. The application of this solution to treads having cutouts of great depth (at least equal to 60 mm) results in the production of blocks of large size; one disadvantage is that these blocks have insufficient rigidity to fulfil the desired function, taking into account the very high stresses to which vehicles having a very high loading capacity are subjected. One possibility consists in providing blocks of rubber of large volume in order to obtain satisfactory rigidity; however, this solution has the disadvantage of requiring a large additional quantity of rubber.

Furthermore, it should be noted that for the tires in question, the need to have available a means for preventing stones from being picked up is only for the new tire and until a state of wear occurs which corresponds substantially to half the thickness of the tread.

### SUMMARY OF THE INVENTION

The object of the invention is to reduce the susceptibility to penetration and retention of stones in the T-shaped connecting region formed by two cutouts of a tread pattern, one of said cutouts opening into the other cutout without completely crossing it, and this when the tire is in the new state and until wear substantially equal to half the depth of the grooves has taken place.

The tread according to the invention comprises elements in relief formed by at least one first and one second cutout which are oriented differently, the first cutout being defined by a first and a second rubber wall spaced apart by a typical distance L1, the second cutout being defined by a first and a second rubber wall spaced apart by a typical distance L2. The first cutout opens into the second cutout without crossing it to form a T-shaped connecting region such that the first and second walls defining the first cutout connect with the first wall defining the second cutout.

The tread pattern according to the invention is characterized in that the second wall of the second cutout is provided, in the connecting region, with a protrusion which extends substantially in the direction of the first cutout, this protrusion having, on a surface parallel to the running surface, a contour in which the point farthest from the second wall is at a distance at least equal to 50% of the width L2 of the second cutout. This protrusion reduces the maximum diameter of a spherical object which can be introduced into said connecting region. This protrusion extends to between 30% and 60% of the depth of the groove in which it is located.

By definition, a first cutout opens into a second cutout without crossing it when this first cutout interrupts only one of the walls of the second cutout.

The effectiveness of each protrusion according to the invention is thus ensured over a large part of the wear of a tread starting from the as-new state. Furthermore, by limiting the maximum depth of each protrusion to 60% of the depth of the groove in which it is located, the performance of the tread pattern with respect to the retention of stones when new is increased without adversely affecting the performance of the tread pattern after wear since the grooves are to some extent re-established in their entire width; furthermore, the additional quantities of rubber needed to form each protrusion are reduced.

The role of each protrusion is to close to a large extent in the radial direction (that is to say, along the thickness of the tread) the zone most susceptible to penetration of stones by reducing the maximum size of the stones and other objects which can be picked up, without substantially modifying the rigidity of the tread pattern elements defined by said cutouts.

The top surface of the protrusion is preferably even with the running surface when new; however, it is conceivable to arrange it slightly recessed beneath the running surface of the tread when new (at most 15% of the groove depth).

### DESCRIPTION OF THE DRAWINGS

The characteristics and advantages of the invention will be better understood on reading the detailed description given hereafter with reference to the drawings, in which:

FIG. 1 shows a partial view of a running surface of a tread in the vicinity of a T-shaped connecting region between two cutouts according to the prior art;

FIG. 2 shows a partial view of a running surface of a tread in the vicinity of a T-shaped connecting region between two cutouts according to the invention;

FIG. 3 shows a section along A-A made through the thickness of the tread shown in FIG. 2;

FIG. 4 shows a tread pattern variant according to the invention which shows a triangular protrusion;

FIG. 5 shows a partial view of a tread pattern according to the invention for a tread of a tire of dimension 44/80 R 57 for a construction vehicle.

### DESCRIPTION OF PREFERRED EMBODIMENTS

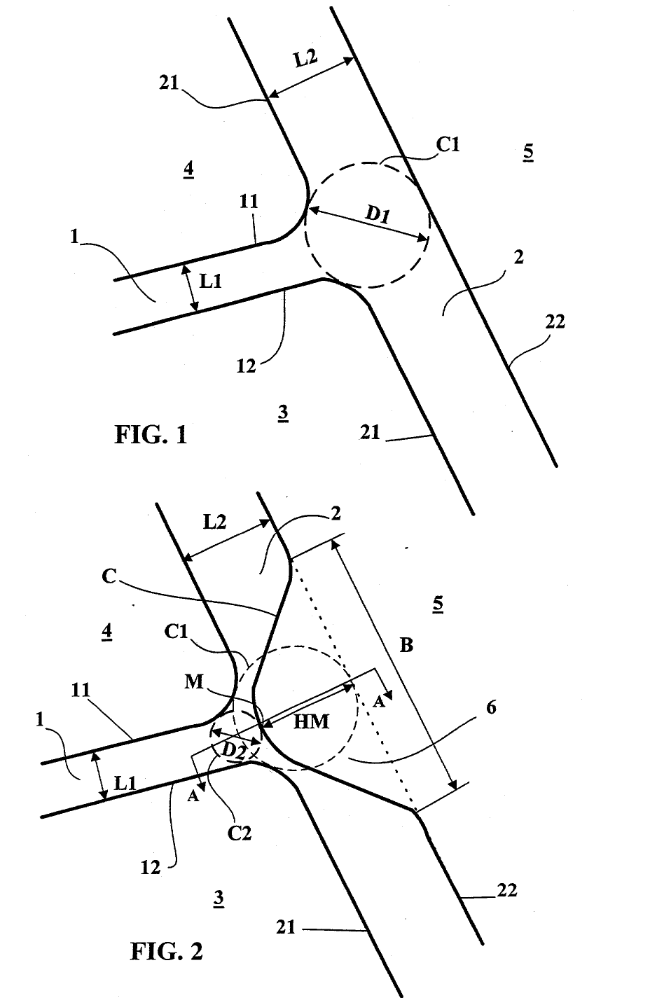

FIG. 1 shows a partial view of a tread in the vicinity of a T-shaped connecting region of two grooves 1, 2 of widths L1 and L2, respectively, said grooves being intersected at right-angles. The first groove 1 is defined by a first wall 11 of a rubber block 4 and by a second wall 12 of a second block 3. The second groove 2 is defined by a first wall 21 bordering the elements 3 and 4, and by a second wall 22 bordering a rubber element 5. In the connecting region, the first wall 11 and the second wall 12 of the first groove 1 are connected to the first wall 21 of the second groove 2.

Furthermore, a circle C1 of diameter D1 represents the contour of a spherical object of the maximum size which can be introduced into the T-shaped connecting region. It can easily be seen that this diameter is greater than the widths L1 and L2 of the grooves 1 and 2.

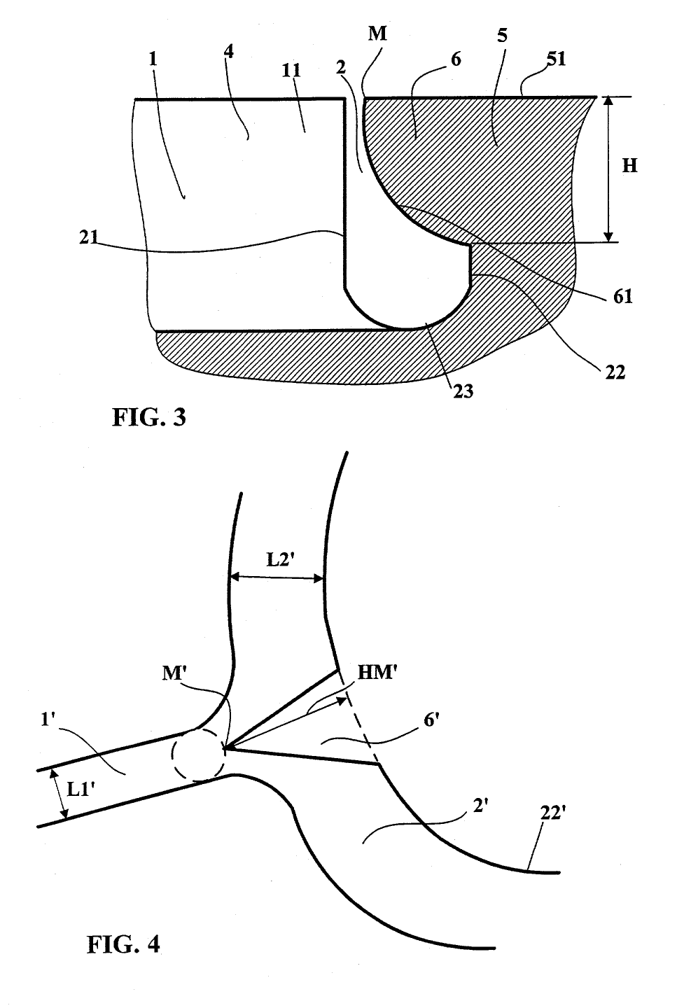

FIG. 2 shows the same partial view of the same tread comprising the tread pattern according to the invention. It can be seen in particular that the second wall 22 of the second groove 2 comprises a rubber protrusion 6 which extends substantially towards the first groove 1 so as to reduce locally the width of the second groove 2. This protrusion 6 has a contour C which is connected tangentially to the initial contour of the second wall 22 of the second groove 2 (the distance B between the points of connection of the contour C of the protrusion 6 with the wall 22 without protrusion being, in the present case, greater than the width L1 of the first groove 1); the point M of said contour C, farthest from said second wall 22 without protrusion (shown in dashes) is located at a distance HM at least equal to the width L2 of the second groove.

In this manner, the maximum width of a spherical object which can be introduced into the connecting region may be substantially reduced; this maximum size is further reduced as the point M is placed farther from the second wall 22 of the second groove 2. In order to indicate the saving obtained, there have been marked in dashes the circle C1 (already shown in FIG. 1) and a circle C2 simulating a spherical object of the maximum dimension which can be introduced into the connecting region, taking into account the presence of the protrusion 6. It is clear that the diameter D2 of this second circle C2 is very much smaller than the diameter D1 of the circle C1.

FIG. 3 shows a view along the section A-A of FIG. 2. On this section, the first wall 11 of the first groove 1 defining the rubber element 4 can be seen, as can a cross-section of the second groove 2 in a section plane passing through the point M of the contour of the protrusion 6 which is farthest from the wall 22 of said second groove 2, and in the thickness of the tread, the same T-shaped connecting region. The profile of the protrusion comprises in this section plane a curved part 61 which is connected to the wall 22 which in turn is connected to the first wall 21 of the second groove 2 via a curved part 23 forming the base of said groove. This curved part 61 makes it possible to obtain a gradual reduction in the space taken up by the protrusion 6 in the width of the groove 2 as the tread becomes worn.

In the example illustrated, the protrusion 6 comprises a curved connecting part, but any other form is also conceivable, for example a rectangular form, arranged so as gradually to reduce the space taken up by the protrusion 6 in the width of the groove 2. The lower connecting point of the protrusion 6 in the present case is located at a distance H from the running surface 51 of the element 5; preferably, this distance H is between 30% and 60% of the depth of the second groove 2.

The presence of a protrusion according to the invention, in addition to the reduction in the maximum size of the objects which can be introduced into the T-shaped connecting region, has the following advantages:

presence of a means opposing the introduction of stones only while this is particularly necessary (between the as-new state and a state corresponding to halfway wear of the tread);

the additional volume of rubber of the protrusions is reduced to what is strictly necessary;

maintenance of the drainage function of each of the grooves, given that there is no closure of said grooves and that the protrusions extend over only part of the height of the grooves;

any object introduced into the T-shaped connecting region thus modified and being displaced towards one or the other of the grooves extending this T-shaped region is not retained by the walls of said grooves since the maximum dimension of said object is less than the widths of said grooves;

no modification of the stiffness of the elements of the tread pattern.

It should be noted that the forms selected for the protrusion permit molding and demoulding without a particular difficulty for the person of ordinary skill in the art.

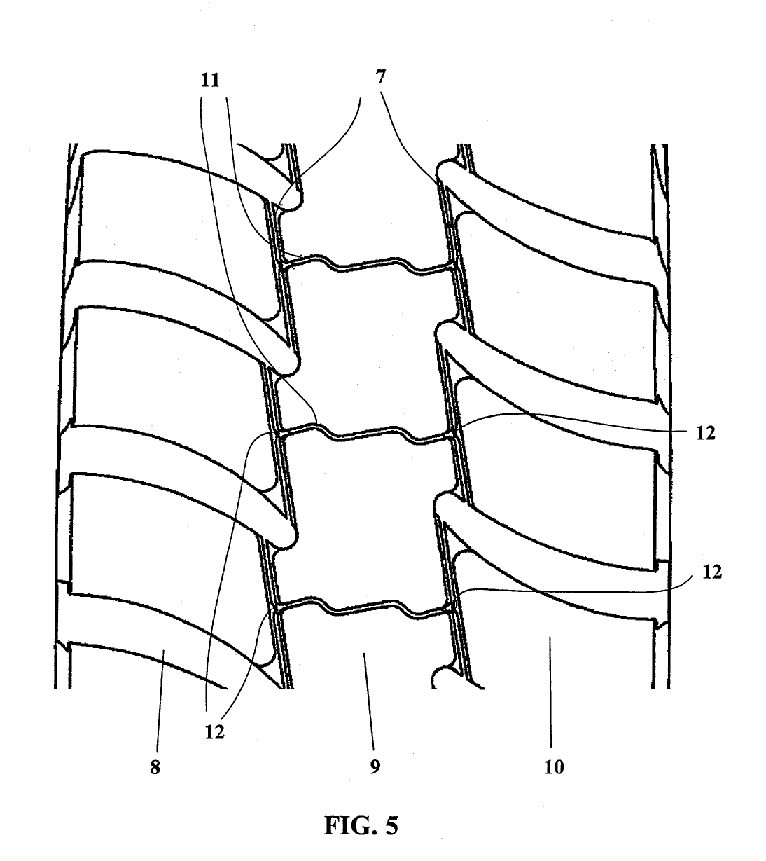

FIG. 4 shows a T-shaped connecting region formed by a first groove 1′ which opens into a second groove 2′, one of the walls 22′ defining the groove 2′ being provided with a protrusion 6′ which extends in the direction of the groove 1′ and has on the running surface a triangular contour, one of the vertexes M′ of which is the point farthest from the wall 22′ and is located at a distance HM′ greater than 100% of the width of the groove 2′. Since this protrusion does not extend over the entire thickness of the tread, the drainage function is still provided by the groove 2′. The base opposite said apex M′ has a length substantially equal to the width L1′ of the groove 1′.

The arrangement according to the invention is applicable in the case of T-shaped connecting regions of two grooves, irrespective of which of said grooves is wider.

FIG. 5 shows a partial view of a tread pattern for a tire for a construction vehicle of dimension 44/80 R 57, the tread pattern depth (that is to say, the height of the rubber elements) of which is equal to about 80 mm.

This tread pattern comprises two grooves 7, of substantially circumferential orientation and of a width of about 8 mm, defining three circumferential strips 8, 9, 10, each of these three circumferential strips having arrangements of tread pattern motifs appropriate to impart to the tread optimum rigidities which enable it to lie flat in the part contacting the ground.

In particular, the central strip 9 is formed of a rib provided with a plurality of grooves 11 of width of about 8 mm and of a depth of about 80 mm. These grooves 11 have two undulations, and extend in a direction substantially perpendicular to the circumferential or longitudinal direction of the tread. These grooves 11 open into each of the circumferential grooves 7 without crossing them.

According to the present invention, the susceptibility of the tread pattern described is reduced by molding, on the lateral wall of the rubber blocks of the shoulders which face the transverse grooves 11 which intersect the central rib and opposite each of said transverse grooves, a protrusion 12 which extends mainly in the transverse direction so as to reduce locally the width of the longitudinal groove 7 without substantially modifying the optimal rigidity of the tread, allowing the tread to lie flat in the part contacting the ground.

In the case shown in FIG. 5, the tread pattern motifs have, when new, beveled ridges along the circumferential grooves and each protrusion 12 is offset by a distance of 5 mm beneath the running surface corresponding to the height of the bevel. Each protrusion 12 extends over 60% of the depth of the circumferential groove 7 and has a contour which extends substantially in the direction of the transverse groove 11 up to a distance slightly greater than the width of the circumferential groove 7.

We claim:

1. A tread for a tire for a vehicle of high loading capacity which travels on bumpy roadways, having a tread pattern comprising elements in relief formed by at least one first and one second cutout which are oriented differently, the first cutout being defined by a first and a second rubber wall spaced apart by a distance L1, the second cutout being defined by a first and a second rubber wall spaced apart by a distance L2; the first cutout opening into the second cutout without crossing it to form a T-shaped connecting region such that the first and second walls defining the first cutout connect with the first wall defining the second cutout, wherein the second wall of the second cutout is provided, in the connecting region, with a protrusion which extends substantially in the direction of the first cutout, this protrusion having, on a surface parallel to the running surface, a contour C, having a point M farthest from the second wall at a distance HM at least equal to 50% of the width L2 of the second cutout, the protrusion extending in the direction of the depth of the second groove from the running surface when new a depth H of between 30% and 60% of the depth of said groove, wherein the protrusion limits the maximum diameter of a spherical object which can be introduced into said connecting region.

2. The tread according to claim 1 wherein the protrusion, when the tire is new, is offset in the direction of the depth of the tread relative to the running surface of said tread, the initial offset being greater than 0% and up to about 15% of the depth of the second groove.

3. The tread according to claim 2 wherein, in a section plane perpendicular to the running surface and passing through the point M of the protrusion which is farthest from the wall of the cutout bearing this protrusion, said protrusion has a trace which is inclined relative to a direction perpendicular to said running surface, such that this protrusion extends less and less into the width of the second groove as the tread becomes worn.

4. The tread according to claim 1 wherein, in a section plane perpendicular to the running surface and passing through the point M of the protrusion which is farthest from the wall of the cutout bearing this protrusion, said protrusion has a trace which is inclined relative to a direction perpendicular to said running surface, such that this protrusion extends less and less into the width of the second groove as the tread becomes worn.

5. A tire for a vehicle of high loading capacity, having a tread, comprising a tread pattern having elements in relief formed by at least one first and one second cutout which are oriented differently, the first cutout being defined by a first and a second rubber wall spaced apart by a distance L1, the second cutout being defined by a first and a second rubber wall spaced apart by a distance L2; the first cutout opening into the second cutout without crossing it to form a T-shaped connecting region such that the first and second walls defining the first cutout connect with the first wall defining the second cutout, wherein the second wall of the second cutout is provided, in the connecting region, with a protrusion which extends substantially in the direction of the first cutout, this protrusion having, on a surface parallel to the running surface, a contour C, having a point M farthest from the second wall at a distance HM at least equal to 50% of the width L2 of the second cutout, the protrusion extending in the direction of the depth of the second groove from the running surface when new a depth H of between 30% and 60% of the depth of said groove, wherein the protrusion limits the maximum diameter of a spherical object which can be introduced into said connecting region.

6. A tire according to claim 5, wherein the protrusion, when the tire is new, is offset in the direction of the depth of the tread relative to the running surface of said tread, the initial offset being greater than 0% and up to about 15% of the depth of the second groove.

7. A tire according to claim 6, wherein, in a section plane perpendicular to the running surface and passing through the point M of the protrusion which is farthest from the wall of the cutout bearing this protrusion, said protrusion has a trace which is inclined relative to a direction perpendicular to said running surface, such that this protrusion extends less and less into the width of the second groove as the tread becomes worn.

8. A tire as in claim 5, wherein, in a section plane perpendicular to the running surface and passing through the point M of the protrusion which is farthest from the wall of the cutout bearing this protrusion, said protrusion has a trace which is inclined relative to a direction perpendicular to said running surface, such that this protrusion extends less and less into the width of the second groove as the tread becomes worn.

9. A tire for a vehicle of high loading capacity comprising a tread provided with a tread pattern having two grooves of substantially circumferential orientation of typical width L1 defining two lateral circumferential strips surrounding a third central strip, the central strip being formed of a rib provided with a plurality of grooves of typical width L2 and extending in a direction perpendicular to the circumferential direction, these grooves opening into each of the circumferential grooves without completely crossing them to form a plurality of T-shaped connecting regions, wherein, opposite at least one of said transverse grooves of the central strip, there is molded on the lateral walls of the lateral strips a protrusion which extends mainly in the transverse direction so as to reduce locally the width of the longitudinal groove by at least 50% at least when new, at least one protrusion extending in the direction of the depth of the grooves of circumferential orientation starting from the running surface when new and over a depth of between 30% and 60% of the depth of said grooves, without substantially modifying the optimal rigidity of the tread, allowing the tread to lie flat in the part contacting the ground.
